(19) United States
(12) Patent Application Publication
(10) Pub. No.: US 2025/0137424 A1
(43) Pub. Date: May 1, 2025

(54) THROTTLE BODY ADAPTER

(71) Applicant: Uzoma Iwuagwu, Grand Rapids, MI (US)

(72) Inventor: Uzoma Iwuagwu, Grand Rapids, MI (US)

(21) Appl. No.: 18/928,718

(22) Filed: Oct. 28, 2024

Related U.S. Application Data
(60) Provisional application No. 63/593,798, filed on Oct. 27, 2023.

(51) Int. Cl. F02M 35/10

(52) U.S. Cl. CPC F02M 35/10144

(57) ABSTRACT

A throttle body adapter has an arcuate protrusion that allows a larger throttle body to be installed in an engine for higher performance without adversely affecting the engine when it operates at idle power or at low power settings. The throttle body adapter has a hollow body with an upstream surface that can be coupled to a throttle body, and a downstream surface that can be coupled to an air intake manifold of the engine. The hollow body has an adapter air passageway in fluid communication with a throttle body air passageway defined by the throttle body. The arcuate protrusion can be inserted into the throttle body air passageway. The throttle body has a valve plate that can be in contact or in close proximity to the arcuate protrusion when the valve plate is at an idle position.

### CROSS REFERENCE TO RELATED APPLICATION

The present application claims the benefit of U.S. provisional application Ser. No. 63/593,798 filed Oct. 27, 2023, which is hereby incorporated herein by reference in its entirety.

### FIELD OF THE DISCLOSURE

The present disclosure relates to throttle body adapters for internal combustion engines.

### BACKGROUND

Internal combustion engines have combustion cylinders that use air and fuel to create power for vehicles and other equipment. To generate more power, the combustion cylinders need more air and fuel. The engine has an air intake manifold for providing air to the combustion cylinders. The amount of air that is delivered to the air intake manifold is controlled by a throttle body. The throttle body may be coupled directly to the air intake manifold or coupled to the throttle body via a throttle body adapter. A larger throttle body can provide more air to the air intake manifold so that the air intake manifold can deliver more air to the combustion cylinders and the engine can generate more power. However, increased airflow through the engine makes it difficult for the engine to operate at a consistent idle speed and output consistent power while the engine is operating at low power settings. For instance, while the engine is idling, the increased airflow of a larger throttle body may cause the idle speed to significantly oscillate. Inconsistent idle speed and inconsistent low power output may reduce fuel economy, reduce performance, and/or create difficulties with starting the engine.

### SUMMARY

A throttle body adapter allows an internal combustion engine to be fitted with a larger throttle body for higher performance, without negatively impacting the efficiency of the engine when it operates at idle speed and low power settings. The engine may have an existing air intake manifold that can be coupled to the larger throttle body via the throttle body adapter. The throttle body adapter has an arcuate protrusion that restricts airflow through the engine when it operates at idle or low power. The restriction in airflow may improve the consistency of the airflow through the engine. For example, the throttle body has a valve plate that may oscillate based on the airflow. The reduction in the airflow may prevent the valve plate from significantly oscillating to improve the consistency in the airflow through the engine. As such, combustion cylinders of the engine can receive a consistent airflow that allows the engine to operate at a more consistent (steady) idle speed and/or output more consistent power while the engine operates at a low speed or power setting.

Although the arcuate protrusion of the throttle body adapter restricts the airflow, the arcuate protrusion may not significantly restrict the airflow through the engine when it operates at wide open throttle or high power settings. As such, the larger throttle body can still provide greater airflow to combustion cylinders in the engine to generate more power without the arcuate protrusion negatively impacting performance at higher power settings. That is, the performance benefits of a larger throttle body may still be achieved with the throttle body adapter having an arcuate protrusion, which mainly affects engine performance at idle and low power settings.

In one form, a throttle body adapter for internal combustion engines includes a hollow body having an upstream surface that can be coupled to a throttle body, and a downstream surface that can be coupled to an air intake manifold. The hollow body has an adapter air passageway defined by an inner adapter wall. The adapter air passageway can receive air from a throttle body air passageway defined by the throttle body. The throttle body adapter has an arcuate protrusion extending in an upstream direction from the upstream surface that can be inserted into the throttle body air passageway. The arcuate protrusion can engage or lie adjacent to a valve plate of the throttle body while the valve plate is at an idle position.

In one aspect, the throttle body adapter defines a gauge port positioned downstream of the arcuate protrusion.

In another aspect, the inner adapter wall has a first portion and a second portion that cooperate to define the entirety of the adapter air passageway, and the arcuate protrusion extends along only the first portion of the inner adapter wall.

In yet another aspect, the arcuate protrusion has an inner side and an outer side. The inner side aligns with the inner adapter wall, and the hollow body extends laterally beyond the outer side.

In yet another aspect, the arcuate protrusion has an inner side and an outer side. The inner side aligns with the inner adapter wall, and the hollow body extends laterally beyond the outer side.

In yet another aspect, the arcuate protrusion has a curved surface that is shaped to allow the valve plate to sweep past the curved surface without contacting the curved surface.

In yet another aspect, the inner adapter wall has a first portion and a second portion that can cooperate to define the entirety of the adapter air passageway. The arcuate protrusion has an inner side and an outer side. The inner side extends along only the first portion of the inner adapter wall, and the hollow body extends laterally beyond the outer side.

In yet another aspect, the outer side of the arcuate protrusion and the second portion of the inner adapter wall can align with the throttle body.

In another form, an engine includes a throttle body, and a throttle body adapter. The throttle body has a throttle body air passageway and a valve plate positioned inside the throttle body air passageway. The throttle body adapter includes a hollow body having an upstream surface that can be coupled to the throttle body and a downstream surface that can be coupled to an air intake manifold. The hollow body has an adapter air passageway that can receive air from the throttle body air passageway. The throttle body adapter has an arcuate protrusion extending in an upstream direction from the upstream surface. The arcuate protrusion can be inserted into the throttle body air passageway. The arcuate protrusion can extend into the throttle body so that the valve plate engages or lies in close proximity to the arcuate protrusion when the valve plate is at an idle position.

In one aspect, the air intake manifold has an air intake manifold passageway that can receive air from the adapter air passageway and the throttle body air passageway.

In another aspect, the valve plate is a portion of a butterfly valve.

In yet another aspect, the hollow body defines a gauge port positioned downstream of the arcuate protrusion.

In yet another form, a throttle body adapter for internal combustion engines includes a hollow body having an upstream portion that can be coupled to a throttle body and a downstream portion that can be coupled to an air intake manifold. The hollow body defines an adapter air passageway that can receive air from a throttle body air passageway defined by the throttle body. The throttle body adapter has an arcuate protrusion that extends in an upstream direction from the upstream portion of the hollow body and can be inserted into the throttle body air passageway. The hollow body defines a plurality of fastener openings positioned radially outboard of the adapter air passageway. The arcuate protrusion can be engaged by a valve plate of the throttle body when the valve plate is at an idle position.

Thus, the throttle body adapter allows a larger throttle body to be installed in an internal combustion engine for higher performance without negatively impacting the efficiency of the engine while operating at idle and low speed, nor the consistency of power output by the engine at low or idle power settings. This is accomplished by the arcuate protrusion of the throttle body adapter that can restrict airflow to a greater degree when the engine operates at idle or low power compared to when the engine operates at wide open throttle or high power. The airflow restricted by the arcuate protrusion may prevent the valve plate from significantly oscillating to allow the engine to run steadily, operate at a consistent idle power, and output consistent power while the engine is operating at a low speed or power settings.

These and other objects, advantages, purposes and features of this disclosure will become apparent upon review of the following specification in conjunction with the drawings.

### BRIEF DESCRIPTION OF DRAWINGS

FIG. 1 is a side sectional view of a throttle body adapter fitted to a throttle body for an internal combustion engine;

FIG. 2 is a perspective view of an upstream end of the throttle body adapter of FIG. 1;

FIG. 3 is a plan view of the upstream end of the throttle body adapter of FIG. 1;

FIG. 4 is a side elevation view of the throttle body adapter of FIG. 1; and

FIG. 5 is another side elevation view of the throttle body adapter of FIG. 1, shown rotated 90 degrees from FIG. 4.

### DESCRIPTION OF THE PREFERRED EMBODIMENTS

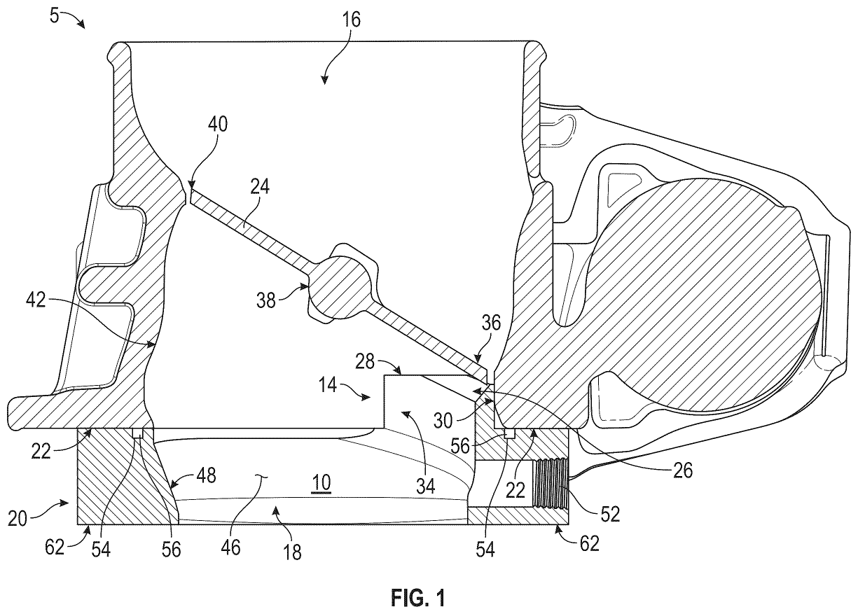

Referring now to the drawings and illustrative embodiments depicted therein, a throttle body 5 for an internal combustion engine is fitted with a throttle body adapter 10 that allows the throttle body 5, which may be larger than an original throttle body provided by the engine manufacturer, to be coupled to an air intake manifold (not shown) for achieving higher performance without negatively impacting the smoothness and efficiency of the engine when it operates at idle speed and/or lower power settings. (FIG. 1). The throttle body adapter 10 has an arcuate protrusion 14 that can restrict airflow through the throttle body 5 when it operates at idle or low power, while not significantly restricting airflow through the throttle body 5 when it operates at wide open throttle or high power so that the larger throttle body 5 can still provide greater airflow through the engine to generate more power. The restriction in airflow while the engine operates at idle or low power allows the larger throttle body 5 to provide a more consistent airflow through the engine, which allows the engine to operate at a consistent idle speed and output consistent power while the engine operates at low power settings.

As shown in FIG. 1, the throttle body 5 has a valve plate 24 that is at or near the idle position in which most of the throttle body air passageway 16 is obstructed. The arcuate protrusion 14 can provide a limited restriction to airflow, particularly when the valve plate 24 is at or near the idle position. The airflow may move in a direction through a throttle body air passageway 16 defined by the throttle body 5, to an adapter air passageway 18 defined by a hollow body 20 of the throttle body adapter 10, and then through the adapter air passageway 18 to a passageway defined by the air intake manifold. The air intake manifold can then distribute the air to combustion cylinders (not shown) to generate power. As used herein, the terms “upstream” and “downstream” are defined relative to such airflow direction.

The arcuate protrusion 14 can be inserted into the throttle body air passageway 16, and an upstream surface 22 of the hollow body 20 can be coupled to a downstream end of the throttle body 5. (FIG. 1). The arcuate protrusion 14 extends in an upstream direction from the upstream surface 22. The arcuate protrusion 14 can engage or lie adjacent to the valve plate 24 within the throttle body air passageway 16 when the valve plate 24 is at an idle position, as shown in FIG. 1.

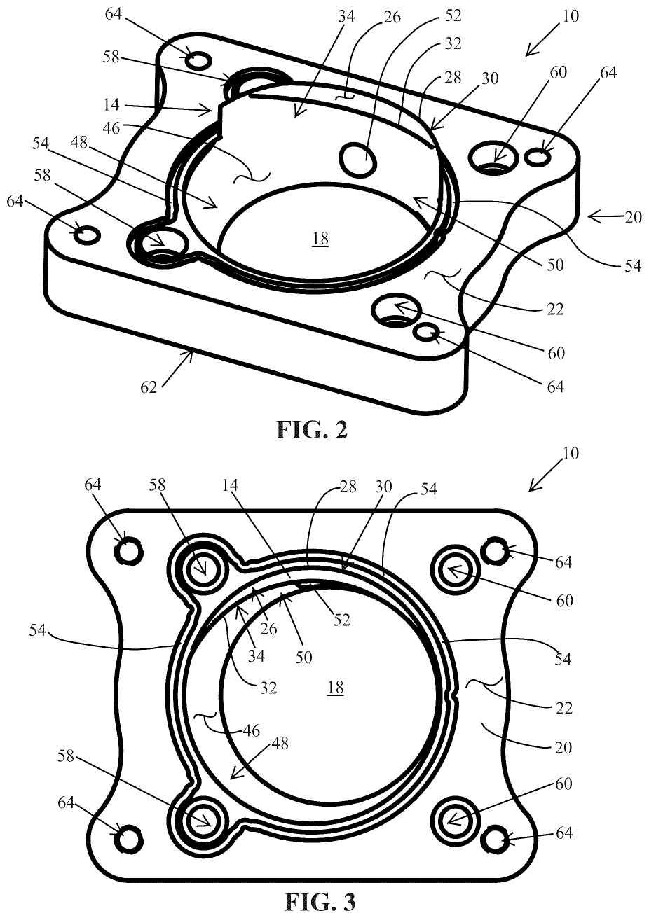

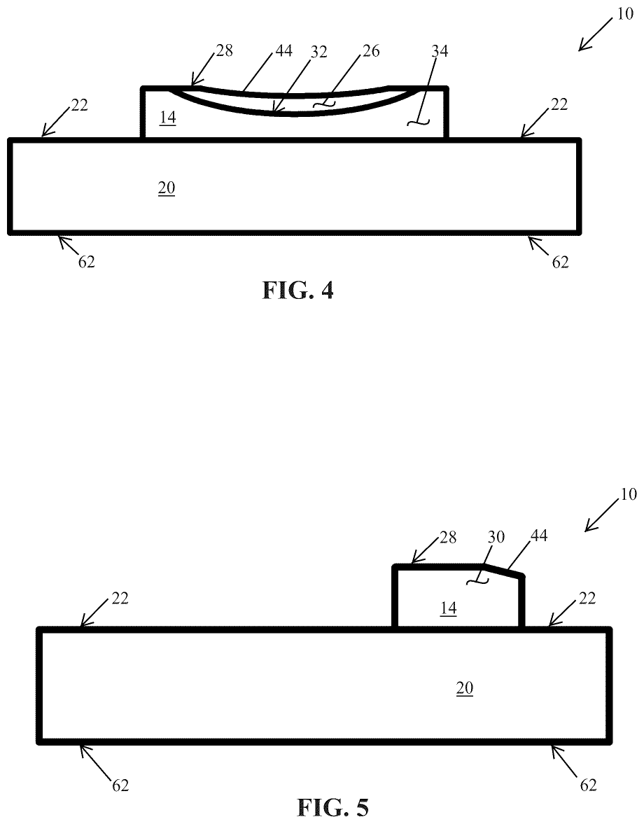

As best shown in FIGS. 2 and 4, the arcuate protrusion 14 has a curved surface 26 that extends from an outer upstream edge 28 of an outer side 30 of the arcuate protrusion 14 to an inner upstream edge 32 of an inner side 34 of the arcuate protrusion 14. The curved surface 26 can lie in close proximity to, or in contact with, the valve plate 24 when the valve plate 24 is at the idle position. (FIG. 1).

The curved surface 26 extends from the outer upstream edge 28 downstream and radially inwardly toward the adapter air passageway 18 to the inner upstream edge 32. (FIGS. 2, 4). In this arrangement, a downstream end 36 of the valve plate 24 can follow the curved surface 26 as the valve plate 24 of the throttle body 5 changes positions. (FIG. 1). In other words, the curved surface 26 is sized and shaped so that the downstream end 36 of the valve plate 24 can sweep past the curved surface 26 without contacting it, and define an arcuate air gap between the outer edge of the downstream end 36 of the valve plate 24 and the curved surface 26. The arcuate air gap may facilitate steady air flow through the throttle body air passageway 16 and adapter air passageway 18 even if the valve plate 24 is oscillating at idle speed.

The positions of the valve plate 24 can be set by a throttle controller of the engine or throttle body 5 according to a desired power output. For example, the desired power output may be indicated by a position of a foot-operated accelerator in a vehicle that is in communication with the throttle controller.

The valve plate 24 may be substantially circular or round in shape. Further, the valve plate 24 may be a part of a butterfly valve where the valve plate 24 changes positions by rotating around a rod 38 of the butterfly valve. (FIG. 1). For instance, the valve plate 24 changes from an idle position, as shown in FIG. 1, to a more open position (e.g., wide open throttle) by rotating clockwise. As the valve plate 24 rotates clockwise, the downstream end 36 of the valve plate 24 follows the curved surface 26 and rotates away from the outer upstream edge 28 of the arcuate protrusion 14, and an upstream end 40 of the valve plate 24 rotates away from an inner throttle body wall 42 that defines the throttle body air passageway 16.

As shown in FIG. 1, when the valve plate 24 is at the idle position, the downstream end 36 lies in close proximity or in contact with the outer upstream edge 28 of the arcuate protrusion 14 that defines a downstream indent 44 (FIGS. 4 and 5), and the upstream end 40 lies in close proximity or in contact with the inner throttle body wall 42. Minimal airflow is available around the valve plate 24 while at the idle position so that minimal airflow travels through the throttle body 5. The minimal airflow through the throttle body 5 can cause the engine to operate at idle power and have a lower rate of fuel consumption than if a higher idle speed is used or uneven idle speed is permitted. The arcuate protrusion 14 may further restrict airflow through the throttle body 5 to prevent the valve plate 24 from oscillating while in the idle position or low power positions, which can improve the consistency of the airflow through the throttle body 5. As a result, the combustion cylinders in the engine can receive a consistent airflow so that the engine can operate at a consistent idle speed and output consistent power while the valve plate 24 is at an idle or low-power position.

As the valve plate 24 changes from the idle position (FIG. 1) to a more open position (e.g., partial or wide open throttle), the valve plate 24 allows more air to flow through the throttle body 5. The larger throttle body 5 can still provide more airflow through the throttle body 5 despite the arcuate protrusion 14 because the airflow is not significantly restricted by the arcuate protrusion 14 while the valve plate 24 is at a wide open throttle or high power position. As a result, the larger throttle body 5 may provide greater airflow than a typical standard throttle body (not shown). The greater airflow can travel through the throttle body air passageway 16 to the adapter air passageway 18, then through the adapter air passageway 18 to the air intake manifold passageway, and then through the air intake manifold passageway to the internal combustion cylinders to generate greater power than an engine having a typical standard throttle body at higher power settings.

The adapter air passageway 18 is defined by an inner adapter wall 46 that has a portion 48 aligned with the inner throttle body wall 42 and a protrusion-side portion 50 aligned with the inner side 34 of the arcuate protrusion 14. In the illustrated embodiment, the protrusion-side portion 50 defines an opening for a gauge port 52 downstream of the arcuate protrusion 14. The gauge port 52 can provide an access point exposed to intake manifold pressure so that an accessory (e.g., a vacuum gauge or a forced-induction boost pressure gauge) can connect to the gauge port 52 and display the intake manifold pressure. The gauge port 52 extends through the hollow body 20 of the throttle body adapter 10 and is open to an exterior side surface of the hollow body 20. Optionally, the gauge port 52 can be fitted with a plug that may be removed when the gauge port 52 is to be used.

As shown in FIGS. 1-3, the hollow body 20 defines a channel 54 that can receive a gasket 56, such as an O-ring, to seal the throttle body 5 to the throttle body adapter 10. As best shown in FIGS. 2 and 3, the channel 54 is disposed radially outboard of the outer side 30 of the arcuate protrusion 14 and a first set of fastener openings 58 defined by the hollow body 20. The air intake manifold may also have a gasket to provide a seal between the air intake manifold and the hollow body 20 of the throttle body adapter 10.

The first set of the fastener openings 58 and a second set of the fastener openings 60 defined by the hollow body 20 can receive a first set of fasteners for attachment of the throttle body adapter 10 to the air intake manifold such that a downstream surface 62 of the throttle body adapter 10 engages an upstream end of the air intake manifold. (FIGS. 2 and 3). A third set of the fastener openings 64 defined by the hollow body 20 can receive a second set of the fasteners for attachment of the throttle body 5 to the throttle body adapter 10 such that the upstream surface 22 of the throttle body adapter 10 engages the downstream end of the throttle body 5.

The second and the third sets of the fastener openings 60, 64 are disposed more radially outwardly away from the adapter air passageway 18 than the channel 54 for gasket 56. The third set of the fastener openings 64 are disposed more radially outwardly away from the adapter air passageway 18 than the first and the second set of the fastener openings 58, 60 so that the throttle body adapter 10 can first be fastened to the air intake manifold by extending fasteners through the first and the second sets of the fastener openings 58, 60, and then the throttle body 5 can be fastened to the throttle body adapter 10 by extending fasteners through the third set of the fastener openings 64. Alternatively, the throttle body 5, throttle body adapter 10, and/or air intake manifold can be secured by utilizing any other fastening elements and/or retaining elements in any other suitable fastening method such as, for example, ultrasonic welding, snap-fit fasteners, cold-swaged connections, etc.

Accordingly, the throttle body adapter 10 allows a larger throttle body 5 to be installed at an internal combustion engine for higher performance without negatively impacting engine idle and low power efficiency. This is accomplished by the arcuate protrusion 14 of the throttle body adapter 10 restricting airflow more when the engine operates at idle or low power compared to when the engine operates at a wide open throttle or high power. The airflow restriction prevents the valve plate 24 from significantly oscillating, which allows the engine to operate at a consistent idle power and output consistent power while the engine is operating at a low power settings.

Connection relationships between elements are described herein using various terms such as, for example, “connected,” “secured,” “engaged,” “attached,” “coupled,” etc. As used herein, connection relationships can be direct relationships and/or indirect relationships where one or more intervening elements are between the first and second elements.

Spatial relationships of elements are described herein using various terms such as, for example, “lateral,” “radially,” “outwardly,” “inwardly,” “upstream,” “downstream,” etc. As used herein, spatial relationships of the elements do not limit the orientations of the elements as other orientations of the elements may be used. An absence of the term “at least one of” does not imply that the use of “a” or “an” means only one.

Changes and modifications in the specifically described embodiments can be carried out without departing from the principles of the present disclosure which is intended to be limited only by the scope of the appended claims, as interpreted according to the principles of patent law including the doctrine of equivalents.

1. A throttle body adapter for internal combustion engines, said throttle body adapter comprising:
a hollow body having an upstream surface configured for coupling to a throttle body and a downstream surface configured for coupling to an air intake manifold, said hollow body having an adapter air passageway defined by an inner adapter wall, said adapter air passageway configured to be in fluid communication with a throttle body air passageway defined by the throttle body; and
an arcuate protrusion extending in an upstream direction from said upstream surface of said hollow body, said arcuate protrusion configured for insertion into the throttle body air passageway;
wherein said arcuate protrusion is configured to engage or lie adjacent to a valve plate of the throttle body when the valve plate is at an idle position.

2. The throttle body adapter of claim 1, wherein said throttle body adapter defines a gauge port positioned downstream of said arcuate protrusion.

3. The throttle body adapter of claim 1, wherein said inner adapter wall comprises a first portion and a second portion that cooperate to define the entirety of said adapter air passageway, wherein said arcuate protrusion extends along only said first portion of said inner adapter wall.

4. The throttle body adapter of claim 1, wherein said arcuate protrusion comprises an inner side and an outer side, wherein said inner side aligns with said inner adapter wall, and wherein said hollow body extends laterally beyond said outer side.

5. The throttle body adapter of claim 1, wherein said arcuate protrusion comprises a curved surface that is shaped to allow the valve plate to sweep past said curved surface without contacting said curved surface.

6. The throttle body adapter of claim 1, wherein said inner adapter wall comprises a first portion and a second portion that cooperate to define the entirety of said adapter air passageway, wherein said arcuate protrusion comprises an inner side and an outer side, wherein said inner side extends along only said first portion of said inner adapter wall, and wherein said hollow body extends laterally beyond said outer side.

7. The throttle body adapter of claim 6, wherein said outer side of said arcuate protrusion and said second portion of said inner adapter wall are configured to align with the throttle body.

8. The throttle body adapter of claim 1, wherein said hollow body further defines a plurality of fastener openings configured to receive fasteners for securing said hollow body to the throttle body and the air intake manifold.

9. The throttle body adapter of claim 8, wherein a first set of said fastener openings are configured to receive first fasteners for attachment of said throttle body adapter to the air intake manifold, and a second set of said fastener openings are configured to receive second fasteners for attachment of said throttle body adapter to the throttle body, wherein said second set of said fastener openings disposed radially outboard of said first set of said fastener openings.

10. The throttle body adapter of claim 1, wherein said upstream surface of said hollow body defines a channel that is configured to receive a gasket to seal said throttle body adapter to the throttle body.

11. An engine comprising:
a throttle body having a valve plate and a throttle body air passageway, said valve plate positioned inside said throttle body air passageway; and
a throttle body adapter having:
a hollow body having an upstream surface configured for coupling to said throttle body and a downstream surface configured for coupling to an air intake manifold, said hollow body having an adapter air passageway defined by an inner adapter wall, said adapter air passageway configured to be in fluid communication with said throttle body air passageway; and
an arcuate protrusion extending in an upstream direction from said upstream surface of said hollow body, said arcuate protrusion configured for insertion into said throttle body air passageway;
wherein said arcuate protrusion is configured to extend into the throttle body so that said valve plate engages or lies in close proximity to said arcuate protrusion when said valve plate is at an idle position.

12. The engine of claim 11, wherein said valve plate is a portion of a butterfly valve.

13. The engine of claim 11, wherein said hollow body defines a gauge port positioned downstream of said arcuate protrusion.

14. The engine of claim 11, wherein said inner adapter wall comprises a first portion and a second portion that cooperate to define the entirety of said adapter air passageway, wherein said arcuate protrusion extends only along said first portion of said inner adapter wall.

15. The engine of claim 11, wherein said arcuate protrusion comprises an inner side and an outer side, wherein said inner side aligns with said inner adapter wall, and wherein said hollow body extends laterally beyond said outer side.

16. The engine of claim 11, wherein said arcuate protrusion comprises a curved surface that is shaped to allow the valve plate to sweep past said curved surface without contacting said curved surface.

17. The engine of claim 11, wherein said inner adapter wall comprises a first portion and a second portion that cooperate to define the entirety of said adapter air passageway, wherein said arcuate protrusion comprises an inner side and an outer side, wherein said inner side extends only along said first portion of said inner adapter wall, and wherein said hollow body extends laterally beyond said outer side.

18. The engine of claim 17, wherein said throttle body air passageway is defined by an inner throttle body wall, said inner throttle body wall is aligned with said outer side of said arcuate protrusion and said second portion of said inner adapter wall.

19. A throttle body adapter for internal combustion engines, said throttle body adapter comprising:
a hollow body having an upstream portion configured for coupling to a throttle body and a downstream portion configured for coupling to an air intake manifold, said hollow body defining an adapter air passageway configured to be in fluid communication with a throttle body air passageway defined by the throttle body; and
an arcuate protrusion extending in an upstream direction from said upstream portion of said hollow body and configured for insertion into the throttle body air passageway;
wherein said hollow body defines a plurality of fastener openings positioned radially outboard of said adapter air passageway; and
wherein said arcuate protrusion is configured to be engaged by or adjacent a valve plate of the throttle body when the valve plate is at an idle position.

20. The throttle body of claim 19, wherein said arcuate protrusion comprises a curved surface that is shaped to allow the valve plate to sweep past said curved surface without contacting said curved surface.
